(19) United States
(12) Patent Application Publication
(10) Pub. No.: US 2015/0172922 A1
(43) Pub. Date: Jun. 18, 2015

(54) METHOD, SYSTEM AND RELEVANT DEVICE FOR REALIZING VIRTUAL SIM CARD

(71) Applicant: ZTE CORPORATION, Shenzhen (CN)

(72) Inventors: Lu An, Shenzhen (CN); Minyao Xu, Shenzhen (CN); Min Lai, Shenzhen (CN)

(21) Appl. No.: 14/402,772

(22) PCT Filed: Apr. 18, 2013
(86) PCT No.: PCT/CN2013/074373

§ 371 Date: Nov. 21, 2014

(30) Foreign Application Priority Data
May 22, 2012 (CN) 201210159453.X

(51) Int. Cl. H04W 12/06; H04W 8/18

(52) U.S. Cl. CPC H04W 12/06; H04W 8/183

(57) ABSTRACT

Provided are a method, system and relevant device for realizing a virtual SIM card. The method includes steps of: when a mobile terminal requests to access a communication network, connecting to a cloud service terminal through a wireless network; after the mobile terminal receives an authentication request sent by the communication network, requesting the cloud service terminal to perform authentication calculation and feeding an authentication result obtained by the authentication calculation back to the mobile terminal; and the mobile terminal sending the received authentication result to the communication network. The solution realizes a mobile terminal with a virtual SIM through a cloud service, and on the basis of inheriting the security of a physical SIM card, not only the production and mounting costs of a SIM card slot are reduced, but also the mobile terminal is allowed to be lighter, thinner and more portable.

### TECHNICAL FIELD

The disclosure relates to the field of communications, and in particular to a method, system and relevant device for realizing a virtual SIM card.

### BACKGROUND

There are two kinds of mobile terminals using a Subscriber Identity Module (SIM) card in the market. One is a machine-card-integrated type, the other is a machine-card-separated type.

For the mobile terminal of the machine-card-separated type, an authentication component is saved in the SIM card. When the mobile terminal performs network access or uses telecommunication services, the authentication component identifies the user identity with operator's network through the key and algorithm in the SIM card to complete the voice and data services. The SIM card is installed within a separate card slot designed in the mobile terminal, and connected with the card slot in the mobile terminal via a mechanical connector. Again, the SIM card is specially made for different operators and can be also designed and manufactured by different manufacturers.

The above technical scheme has many defects, which are specifically described as follows.

The SIM card slot is designed in the mobile terminal, which increases the cost and thickens the mobile terminal. For the requirements that the high-end models pursuit light and thin appearance, it will inevitably result in serious defects.

The mechanical connector connecting the SIM card and the card slot also results in the possible damage of the card slot, which brings unnecessary losses to the user.

A huge amount of subscriber information is saved in the SIM card. Since a lot of manufacturers are capable of producing SIM cards, it is possible to give criminals a chance to copy the SIM cards, which causes losses to the users.

If a user wants to purchase a SIM card after purchasing a mobile terminal, he/she needs to firstly determine that he/she plans to select which operator for accessing the network, and then purchase the SIM card at the service centre designated by this operator. But it is impossible for the user to take the mobile terminal home and access the network by selecting an operator on the Internet after purchasing the mobile terminal. If the user wants to change the number, he/she must re-purchase a new SIM card, which is not only a troublesome thing for the user, but also wastes the resources.

### SUMMARY

In view of the analysis above, the embodiments of the disclosure provide a method, system and relevant device for realizing a virtual SIM card, which overcomes many defects brought by a physical SIM card in the existing mobile terminal of a machine-card-separated type.

An embodiment of the disclosure provides a method for realizing a virtual SIM card, including steps of:

when a mobile terminal requests to access a communication network, connecting to a cloud service terminal through a wireless network;

after the mobile terminal receives an authentication request sent by the communication network, requesting the cloud service terminal to perform authentication calculation and feeding an authentication result obtained by the authentication calculation back to the mobile terminal; and

sending, by the mobile terminal, the received authentication result to the communication network.

Preferably, the above method further includes that:

the communication network performs authentication according to the authentication result received from the mobile terminal, wherein if the authentication is passed, the mobile terminal access is allowed, otherwise, accessing the communication network is not allowed.

Preferably, connecting to the cloud service terminal through the wireless network includes that:

the cloud service terminal verifies the validity of the mobile terminal, wherein if the verification is passed, a normal connection is performed, otherwise, accessing the cloud service terminal is not allowed.

Preferably, the validity verification includes that:

when the mobile terminal sends a new value obtained by calculating a preset user name and a preset password that are used during connecting the cloud service terminal according to a predefined algorithm to the cloud service terminal through the wireless network, the cloud service terminal decrypts the received new value adopting the same predefined algorithm, and compares the user name and the password decrypted with the user name and the password prestored by the cloud service terminal corresponding to the mobile terminal, wherein if the comparison result is that the user name and the password decrypted are the same as the user name and the password prestored, the verification is passed.

Preferably, when the authentication request sent by the communication network contains a random number, the cloud service terminal performs the authentication calculation includes that:

the mobile terminal sends the random number to the cloud service terminal, the cloud service terminal obtains a corresponding response number by calculating the random number by an algorithm and a key prestored for authentication, and feeds the response number back to the mobile terminal.

Preferably, the communication network performs authentication includes that:

when the mobile terminal sends the response number to the communication network, the communication network compares the received response number with the prestored response number, wherein if the comparison result is the received response number is the same as the prestored response number, the authentication is passed, otherwise, access is not allowed; wherein the prestored response number corresponds to the random number in the authentication request.

The disclosure further provides a system for realizing a virtual SIM card, including: a mobile terminal and a cloud service terminal, wherein the mobile terminal includes: a cloud interface component and a sending component, wherein

the cloud interface component is configured to, when accessing a communication network is requested, connect to the cloud service terminal through a wireless network, and after an authentication request sent by the communication network is received, request the cloud service terminal to perform authentication calculation;

the cloud service terminal is configured to perform authentication calculation and feed an authentication result obtained by the authentication calculation back to the mobile terminal; and

the sending component is configured to send the authentication result received by the mobile terminal to the communication network.

Preferably, the system further includes an authentication component in the communication network, configured to perform authentication according to the authentication result received from the mobile terminal, wherein if the authentication is passed, the mobile terminal access is allowed, otherwise, the mobile terminal is not allowed to access the communication network.

The disclosure further provides a mobile terminal, including:

a cloud interface component, configured to, when accessing a communication network is requested, connect to a cloud service terminal through a wireless network, and after an authentication request sent by the communication network is received, request the cloud service terminal to perform authentication calculation and feed back an authentication result; and

a sending component, configured to send the authentication result received from the cloud service terminal by the mobile terminal to the communication network.

Preferably, when the cloud service terminal verifies the validity of the mobile terminal, the sending component is further configured to obtain a new value by calculating a preset user name and a preset password that are used when the mobile terminal connects to the cloud service terminal according to a predefined algorithm, and send the new value to the cloud service terminal through the wireless network.

Another embodiment of the disclosure provides a cloud service terminal, including:

an authentication calculation component, configured to perform authentication calculation according to a request of a mobile terminal; and

a sending component, configured to feed the calculated authentication result back to the mobile terminal.

In the described embodiment, the cloud service terminal further includes:

a verification component, configured to verify the validity of the mobile terminal, wherein if the verification is passed, a normal connection is performed, otherwise, the mobile terminal is not allowed to access the cloud service terminal.

Preferably, the verification component is further configured to, when the cloud service terminal receives a new value obtained by calculating a preset user name and a preset password that are used during connecting to the cloud service terminal according to a predefined algorithm by the mobile terminal, decrypt the received new value adopting the same predefined algorithm, and compare the user name and the password decrypted with the user name and the password prestored by the cloud service terminal corresponding to the mobile terminal, if the comparison result is that the user name and the password decrypted are the same as the user name and the password prestored, the verification is passed.

The solution of the embodiments of the disclosure has the following beneficial effects:

The solution realizes a mobile terminal with a virtual SIM through a cloud service, and on the basis of inheriting the security of a physical SIM card, not only are the production and mounting costs of a SIM card slot reduced, but also the mobile terminal is allowed to be lighter, thinner and more portable.

Other features and advantages of the disclosure will be set forth in the following description and partly may be obvious from the description, or may be understood by implementing the disclosure. The objects and other advantages of the disclosure can be realized and obtained through the structures indicated by the description, claims and drawings.

### BRIEF DESCRIPTION OF THE DRAWINGS

FIG. 1 is a flow diagram of a method according to an embodiment of the disclosure;

FIG. 2 is a structure diagram of a system according to an embodiment of the disclosure;

FIG. 3 is a structure diagram of a mobile terminal according to an embodiment of the disclosure; and

FIG. 4 is a structure diagram of a cloud service terminal according to an embodiment of the disclosure.

### DETAILED DESCRIPTION OF THE EMBODIMENTS

The example embodiments of the disclosure are described in detail below in conjunction with accompanying drawings, wherein the accompanying drawings constitute a portion of the application and is used to illustrate the principle of the disclosure together with the embodiments of the disclosure. In order to clarify and simplify the embodiments, when the theme of the disclosure may be incurred to be indefinable, the detailed and specific illustration of the known functions and structures in the devices described in the specification will be omitted.

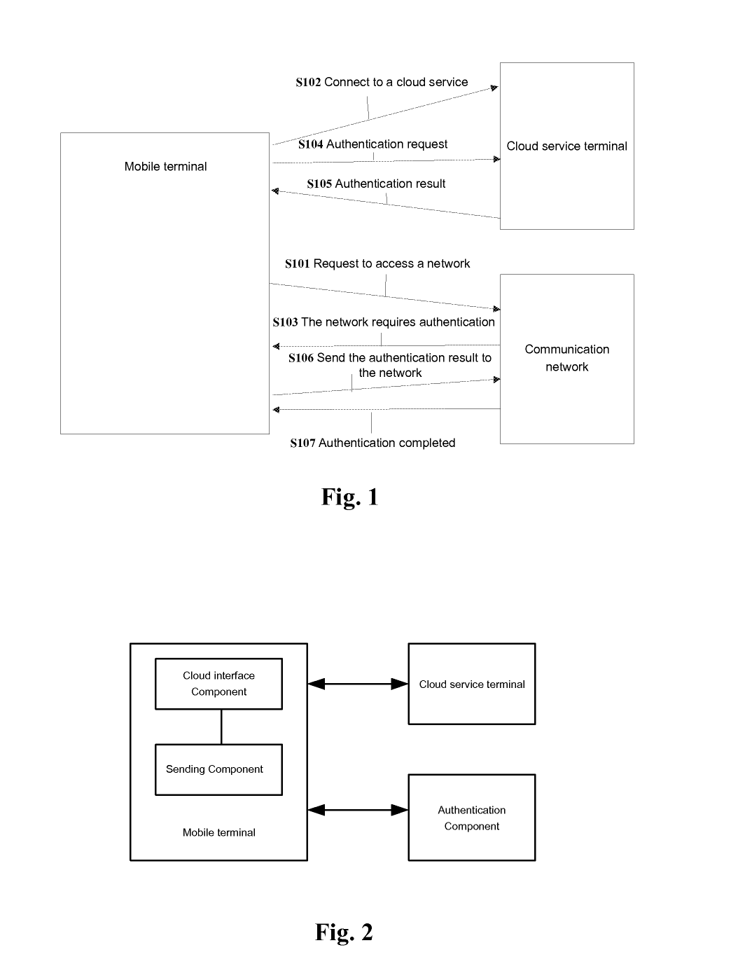

Firstly, a method according to an embodiment of the disclosure is illustrated in detail in conjunction with FIG. 1.

As shown in FIG. 1, FIG. 1 is a flow diagram of a method according to an embodiment of the disclosure, including the following steps:

Step 101: When a mobile terminal initiates a service, including the mobile terminal switching on, registering, call establishment attempt, position updating and activating, deactivating, registering or deleting supplementary services or the like, accessing a communication network is requested.

Step 102: The mobile terminal connects to a cloud service terminal through a wireless network. In an example embodiment, after an algorithm is designed in the mobile terminal in advance, a new value is obtained by calculating a user name and a password of the mobile terminal by the predefined algorithm, the cloud service terminal is connected through the wireless network while the new value obtained by calculating is accompanied. In the cloud service terminal, the new value is decrypted by the same predefined algorithm to check whether the identity of the mobile terminal is a valid user. That is, the user name and the password decrypted are compared with the user name and the password prestored by the cloud service terminal corresponding to the mobile terminal, if the comparison result is that the user name and the password obtained by decryption are the same as the user name and the password which are prestored, a normal connection is performed, otherwise, the mobile terminal is not allowed to access.

Step 103: After the mobile terminal initiates an access request to the communication terminal, the communication network sends a random number to the mobile terminal through a control channel.

Step 104: The mobile terminal sends an authentication request to the cloud service terminal. In an example embodiment, since the mobile terminal has been connected to the cloud service terminal at Step 102, at this step, the mobile terminal may send the random number received from the communication network to the cloud service terminal. After receiving the random number, the cloud service terminal obtains a response number through calculating the random number according to an algorithm and a key prestored for authentication.

Step 105: The cloud service terminal sends the authentication result to the mobile terminal. That is, the cloud service terminal sends the response number obtained by calculating to the mobile terminal.

Step 106: The mobile terminal sends the authentication result to the network. That is, the mobile terminal sends the response number fed back by the cloud service terminal to the communication network.

Step 107: The communication network compares the received response number with the response number prestored (the response number corresponding to the random number in the authentication request previously sent). If the comparison result is that the received response number and the response number prestored are the same, the mobile terminal is allowed to access, otherwise the mobile terminal is an invalid user and the communication network refuses to serve the mobile terminal. This is because the random number sent to the mobile terminal by the wireless network and the random number actually received by the mobile terminal should be the same, and the same key and the same algorithm are used, so that the response numbers should be the same.

Next, a system according to an embodiment of the disclosure is illustrated in detail in conjunction with FIG. 2.

As shown in FIG. 2, FIG. 2 is a structure diagram of a system according to an embodiment of the disclosure, including:

a mobile terminal and a cloud service terminal, wherein the mobile terminal comprises: a cloud interface component and a sending component, wherein

the cloud interface component is configured to, when accessing a communication network is requested, connect to a cloud service terminal through a wireless network, and after an authentication request sent by the communication network is received, request the cloud service terminal to perform authentication calculation;

the cloud service terminal is configured to perform authentication calculation and feed an authentication result obtained by the authentication calculation back to the mobile terminal; and

the sending component is configured to send the authentication result received by the mobile terminal to the communication network.

As a example embodiment of the disclosure, the system may also comprise an authentication component configured in the communication network, configured to perform authentication according to the authentication result received from the mobile terminal, wherein if the authentication is passed, the mobile terminal access is allowed, otherwise, the mobile terminal is not allowed to access the communication network.

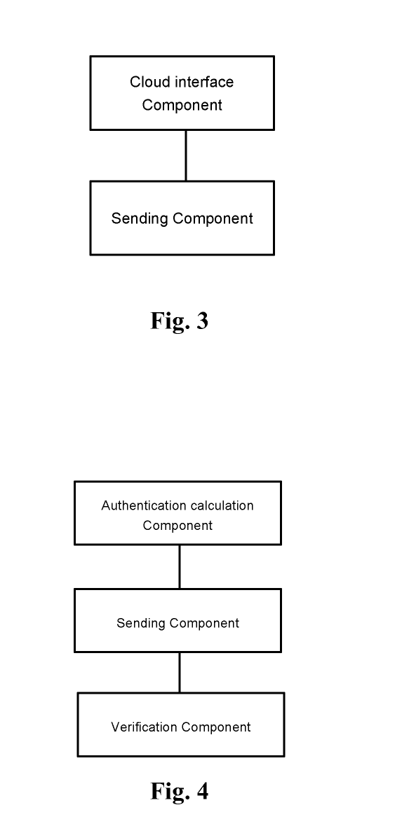

The specific implementation of the mobile terminal and the cloud service terminal will be illustrated in detail below in conjunction with FIG. 3 and FIG. 4.

As shown in FIG. 3, FIG. 3 is a structure diagram of a mobile terminal according to an embodiment of the disclosure, including:

a cloud interface component, configured to, when accessing a communication network is requested, connect to a cloud service terminal through a wireless network, and after an authentication request sent by the communication network is received, request the cloud service terminal to perform authentication calculation and feed back an authentication result; and

a sending component, configured to send the authentication result to the communication network, and the authentication result is that the mobile terminal receives from the cloud service terminal.

When the cloud service terminal verifies the validity of the mobile terminal, the sending component also needs to obtain a new value by calculating a preset user name and a preset password that are used when the mobile terminal connects to the cloud service terminal according to a predefined algorithm, and send the new value to the cloud service terminal through the wireless network.

As shown in FIG. 4, FIG. 4 is a structure diagram of a cloud service terminal according to an embodiment of the disclosure, including:

an authentication calculation component, configured to perform authentication calculation according to a request of a mobile terminal; and

a sending component, configured to feed the authentication result obtained by calculating back to the mobile terminal.

As an example embodiment of the disclosure, the cloud service terminal further includes:

a verification component, configured to verify the validity of the mobile terminal, wherein if the verification is passed, a normal connection is performed, otherwise, the mobile terminal is not allowed to access the cloud service terminal. Specifically, when the cloud service terminal receives a new value obtained by calculating a preset user name and a preset password that are used when the mobile terminal connects the cloud service terminal according to a predefined algorithm, the verification component decrypts the new received value adopting the same predefined algorithm, and compares the user name and the password which are decrypted with the user name and the password which are prestored by the cloud service terminal corresponding to the mobile terminal, wherein if the comparison result is that the user name and the password which are decrypted are the same as the user name and the password which are prestored, the verification is passed.

To sum up, the embodiments of the disclosure provide a method, system and relevant device for realizing a virtual SIM card. A mobile terminal realizing the virtual SIM through cloud service has the following characteristics:

1. The mobile terminal is a thin terminal. No SIM card slot is designed, and no SIM card is inserted. In this way, since no SIM card slot is designed in the mobile terminal, the cost is reduced, and lots of obstacles are reduced for designing a lighter and thinner mobile terminal. Moreover, the user himself can select an operator to access the network through the Internet instead of purchasing a SIM card at the service centre of the operator.

2. The authentication component is saved in the cloud service terminal and the authentication operation is performed in the cloud service terminal. That is, when the voice or data services are performed, after the services are initiated, the cloud service terminal is firstly connected by a user name and a password through a wireless network. When the user name and the password are sent to the cloud service terminal, an encryption algorithm is adopted to ensure the security of users. When the communication network requires authentication to the mobile terminal, the mobile terminal sends the data of the authentication request to the cloud service terminal and requests an authentication result at the same time. Then the mobile terminal sends the authentication result to the communication network. The authentication process ends.

The above is only the example embodiments of the disclosure and not intended to limit the protection scope of the disclosure, and any changes or replacements easily obtained by those skilled in the art within the technical scope disclosed by the disclosure shall fall in the protection scope of the disclosure. Consequently, the protection scope of the disclosure shall be based on the protection scope of the claims.

1. A method for realizing a virtual SIM card, comprising:
when a mobile terminal requests to access a communication network, connecting to a cloud service terminal through a wireless network;
after the mobile terminal receives an authentication request sent by the communication network, requesting the cloud service terminal to perform authentication calculation and feeding an authentication result obtained by the authentication calculation back to the mobile terminal; and
sending, by the mobile terminal, the received authentication result to the communication network.

2. The method according to claim 1, further comprising:
the communication network performing authentication according to the authentication result received from the mobile terminal, wherein if the authentication is passed, the mobile terminal is allowed to access the communication network, otherwise, the mobile terminal is not allowed to access the communication network.

3. The method according to claim 1, wherein connecting to the cloud service terminal through the wireless network comprises:
the cloud service terminal verifying the validity of the mobile terminal, wherein if the verification is passed, a normal connection is performed, otherwise, the mobile terminal is not allowed to access the cloud service terminal.

4. The method according to claim 3, wherein the validity verification comprises:
when the mobile terminal sends a new value, obtained by calculating a preset user name and a preset password that are used when the mobile terminal connects to the cloud service terminal according to a predefined algorithm, to the cloud service terminal through the wireless network, the cloud service terminal decrypting the received new value adopting the same predefined algorithm, and comparing the user name and the password decrypted with a user name and a password prestored by the cloud service terminal corresponding to the mobile terminal, wherein if the comparison result is that the user name and the password decrypted are the same as the user name and the password prestored, the verification is passed.

5. The method according to claim 2, wherein when the authentication request sent by the communication network contains a random number, the cloud service terminal performing the authentication calculation comprises:
the mobile terminal sending the random number to the cloud service terminal, the cloud service terminal obtaining a corresponding response number by calculating the random number by an algorithm and a key prestored for the authentication, and feeding the response number back to the mobile terminal.

6. The method according to claim 5, wherein the communication network performing the authentication comprises:
when the mobile terminal sends the response number to the communication network, the communication network comparing the received response number with a prestored response number, wherein if the comparison result is the received response number is the same as the prestored response number, the authentication is passed, otherwise, access is not allowed; wherein the prestored response number corresponds to the random number in the authentication request.

7. (canceled)

8. (canceled)

9. A mobile terminal, comprising:
a cloud interface component, configured to connect to a cloud service terminal through a wireless network when accessing a communication network is requested, and after an authentication request sent by the communication network is received, request the cloud service terminal to perform authentication calculation and feed back an authentication result; and
a sending component, configured to send the authentication result received from the cloud service terminal by the mobile terminal to the communication network.

10. The mobile terminal according to claim 9, wherein when the cloud service terminal verifies the validity of the mobile terminal, the sending component is configured to obtain a new value by calculating a preset user name and a preset password that are used when the mobile terminal connects to the cloud service terminal according to a predefined algorithm, and send the new value to the cloud service terminal through the wireless network.

11. A cloud service terminal, comprising:
an authentication calculation component, configured to perform authentication calculation according to a request of a mobile terminal; and
a sending component, configured to feed a calculated authentication result back to the mobile terminal.

12. The cloud service terminal according to claim 11, wherein the cloud service terminal further comprises:
a verification component, configured to verify the validity of the mobile terminal, wherein if the verification is passed, a normal connection is performed, otherwise, the mobile terminal is not allowed to access the cloud service terminal.

13. The cloud service terminal according to claim 12, wherein the verification component is further configured to, when the cloud service terminal receives a new value obtained by calculating a preset user name and a preset password that are used during connecting to the cloud service terminal according to a predefined algorithm by the mobile terminal, decrypt the received new value adopting the same predefined algorithm, and compare the user name and the password decrypted with the user name and the password prestored by the cloud service terminal corresponding to the mobile terminal, wherein if the comparison result is that the user name and the password decrypted are the same as the user name and the password prestored, the verification is passed.

14. The method according to claim 2, wherein connecting to the cloud service terminal through the wireless network comprises:
the cloud service terminal verifying the validity of the mobile terminal, wherein if the verification is passed, a normal connection is performed, otherwise, the mobile terminal is not allowed to access the cloud service terminal.

15. The method according to claim 14, wherein the validity verification comprises:
when the mobile terminal sends a new value, obtained by calculating a preset user name and a preset password that are used when the mobile terminal connects to the cloud service terminal according to a predefined algorithm, to the cloud service terminal through the wireless network, the cloud service terminal decrypting the received new value adopting the same predefined algorithm, and comparing the user name and the password decrypted with a user name and a password prestored by the cloud service terminal corresponding to the mobile terminal, wherein if the comparison result is that the user name and the password decrypted are the same as the user name and the password prestored, the verification is passed.

16. A system for realizing a virtual SIM card, comprising: a mobile terminal according to claim 9 and a cloud service terminal, wherein
the cloud service terminal is configured to perform the authentication calculation and feed an authentication result obtained by the authentication calculation back to the mobile terminal.

17. The system according to claim 16, wherein the system further comprises an authentication component in the communication network, configured to perform authentication according to the authentication result received from the mobile terminal, wherein if the authentication is passed, the mobile terminal is allowed to access, otherwise, the mobile terminal is not allowed to access the communication network.

18. A system for realizing a virtual SIM card, comprising: a mobile terminal according to claim 10 and a cloud service terminal, wherein
the cloud service terminal is configured to perform the authentication calculation and feed an authentication result obtained by the authentication calculation back to the mobile terminal.

19. The system according to claim 18, wherein the system further comprises an authentication component in the communication network, configured to perform authentication according to the authentication result received from the mobile terminal, wherein if the authentication is passed, the mobile terminal is allowed to access, otherwise, the mobile terminal is not allowed to access the communication network.
